(19) United States
(12) Patent Application Publication
(10) Pub. No.: US 2008/0278551 A1
(43) Pub. Date: Nov. 13, 2008

(54) FLUID FLOW DEVICE AND PRINTING SYSTEM

(76) Inventors: Jinquan Xu, Rochester, NY (US); Zhanjun Gao, Rochester, NY (US)

Correspondence Address: David A. Novais;Patent Legal Staff, Eastman Kodak Company, 343 State Street, Rochester, NY, 14650-2201, US

(21) Appl. No.: 11/746,117

(22) Filed: May 9, 2007

(51) Int. Cl. B41J 2/175; F01D 1/36

(52) U.S. Cl. 347/85; 416/1; 416/4

(57) ABSTRACT

A fluid flow device, a method of moving fluid, and a printing system incorporating the device are provided. The fluid flow device includes a passage for a fluid including a wall with the wall having a travel path. A fluid flow source is operable to cause the fluid to flow in a direction through the passage. The travel path of the wall is in the same direction as that of the fluid flow.

### CROSS REFERENCE TO RELATED APPLICATIONS

Reference is made to commonly-assigned, U.S. patent application Ser. No. ______ (Kodak Docket No. 92244), filed currently herewith, entitled “PRINTER DEFLECTOR MECHANISM INCLUDING LIQUID FLOW”,” and U.S. patent application Ser. No. ______ (Kodak Docket No. 91725), filed currently herewith, entitled “FLUID FLOW DEVICE FOR A PRINTING SYSTEM.”

### FIELD OF THE INVENTION

This invention relates generally to the management of fluid flow and, in particular to the management of fluid flow in printing systems.

### BACKGROUND OF THE INVENTION

Printing systems that deflect drops using a gas flow are known, see, for example, U.S. Pat. No. 4,068,241, issued to Yamada, on Jan. 10, 1978.

The device that provides gas flow to the gas flow drop interaction area can introduce turbulence in the gas flow that may augment and ultimately interfere with accurate drop deflection or divergence. Turbulent flow introduced from the gas supply typically increases or grows as the gas flow moves through the structure or plenum used to carry the gas flow to the gas flow drop interaction area of the printing system.

Drop deflection or divergence can be affected when turbulence, the randomly fluctuating motion of a fluid, is present in, for example, the interaction area of the drops that are traveling along a path and the gas flow force. The effect of turbulence on the drops can vary depending on the size of the drops. For example, when relatively small volume drops are caused to deflect or diverge from the path by the gas flow force, turbulence can randomly disorient small volume drops resulting in reduced drop deflection or divergence accuracy which, in turn, can lead to reduced drop placement accuracy.

Accordingly, a need exists to reduce turbulent gas flow in printing systems.

### SUMMARY OF THE INVENTION

According to one aspect of the present invention, a fluid flow device includes a passage for a fluid including a wall. A fluid flow source is operable to cause the fluid to flow in a direction through the passage. The wall of the passage has a travel path with the travel path of the wall being in the same direction as that of the fluid flow.

According to another aspect of the present invention, a printing system includes a liquid drop ejector operable to eject liquid drops having a plurality of volumes along a first path and a passage for a fluid including a wall. A fluid flow source is operable to cause the fluid to flow in a direction through the passage. The wall of the passage has a travel path with the travel path of the wall being in the same direction as that of the fluid flow. Interaction of the fluid flow and the liquid drops causes liquids drops having one of the plurality of volumes to begin moving along a second path.

According to another aspect of the present invention, a method of moving fluid includes providing a passage including a wall; providing a fluid flow from a fluid flow source, the fluid moving in a direction through the passage; and moving the wall along a travel path in the same direction as that of the fluid flow.

### BRIEF DESCRIPTION OF THE DRAWINGS

In the detailed description of the preferred embodiments of the invention presented below, reference is made to the accompanying drawings, in which:

FIGS. 1A and 1B are schematic side views of example embodiments of the present invention;

FIG. 2A is a schematic side view of a printing system that can incorporate an example embodiment of the present invention;

FIG. 2B is a schematic perspective view of the printing system shown in FIG. 2A;

FIG. 3 is a schematic side view of another printing system that can incorporate an example embodiment of the present invention;

FIG. 4 is a schematic side view of another printing system incorporating another example embodiment of the present invention;

FIG. 5 is a schematic side view of another printing system incorporating another example embodiment of the present invention;

FIG. 6 is a schematic side view of another printing system incorporating another example embodiment of the present invention;

FIG. 7 is a schematic side view of another printing system incorporating another example embodiment of the present invention; and

FIG. 8 is a schematic side view of another printing system incorporating another example embodiment of the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

The example embodiments of the present invention are illustrated schematically and not to scale for the sake of clarity. One of ordinary skill in the art will be able to readily determine the specific size and interconnections of the elements of the example embodiments of the present invention. In the following description, identical reference numerals have been used, where possible, to designate identical elements.

Although the term printing system is used herein, it is recognized that printing systems are being used today to eject other types of liquids and not just ink. For example, the ejection of various fluids such as medicines, inks, pigments, dyes, and other materials is possible today using printing systems. As such, the term printing system is not intended to be limited to just systems that eject ink.

When present in printing systems, for example, like those described above which are commonly referred to as continuous printing systems, turbulence, particularly wall-turbulence in the drop deflector system, is induced mainly by boundary (wall) friction (drag on the gas flow, for example, air, exerted by the walls of the deflector system). Drag and therefore turbulence can be reduced or even eliminated by actively controlling the boundary (wall) regions of the system. Boundary regions include, for example, areas of the system where the gas flow is adjacent to a stationary portion, for example, a wall, of the system.

Drag reduction is accompanied by reductions in the magnitude of shear stress, commonly referred to as Reynolds shear stress, throughout the gas flow. This also helps to reduce or even eliminate turbulence. For example, when a wall or web, located along a boundary region, is moving in the same direction and at substantially the same velocity as that of the gas flow, drag can be reduced and the gas flow, for example, a laminar gas flow, can be maintained in the drop deflector system. The moving wall or web decreases or even eliminates the fluid velocity gradient induced by boundary friction.

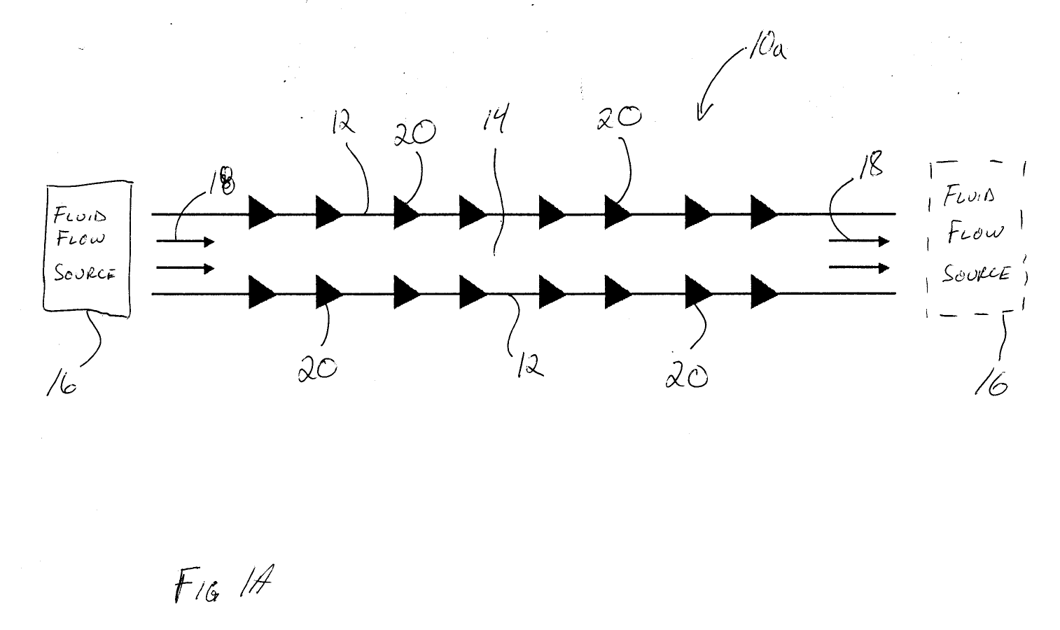

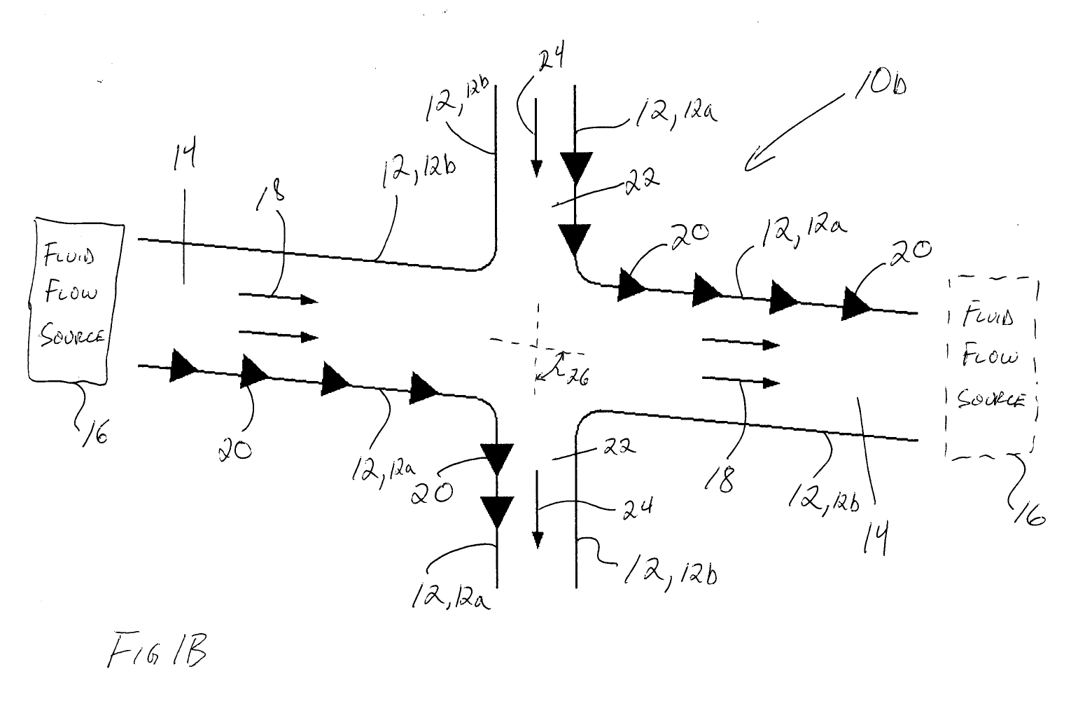

Referring to FIGS. 1A and 1B, schematic side views of a fluid flow device 10 (10a in FIG. 1A and 10b in FIG. 10b) that can reduce turbulence are shown. Fluid flow devices 10a and 10b includes a wall or walls 12 that define a passage 14. A fluid flow source 16 is operatively associated with passage 14 and is operable to cause fluid, for example, a gas, to flow in a direction (represented by arrows 18 in FIGS. 1A and 1B) through passage 14.

Fluid flow source 16 can be any type of mechanism commonly used to create a fluid flow. For example, fluid flow source 16 can be a positive pressure type flow source such as a fan or a blower. Alternatively, fluid flow source 16 can be of the type that creates a negative pressure or a vacuum. Positioning of fluid flow source 16 relative to passage 14 depends on the type of fluid flow source 16 used. For example, when a positive pressure fluid flow source 16 is used, fluid flow source can be located at a front side of passage 14 (left hand side as shown in FIGS. 1A and 1B). When a negative pressure fluid flow source 16 is used, fluid flow source 16 can be located at a back side of passage 14 (right hand side as shown in FIGS. 1A and 1B). Fluid flow source 16 can also be a combination of positive and negative pressure sources.

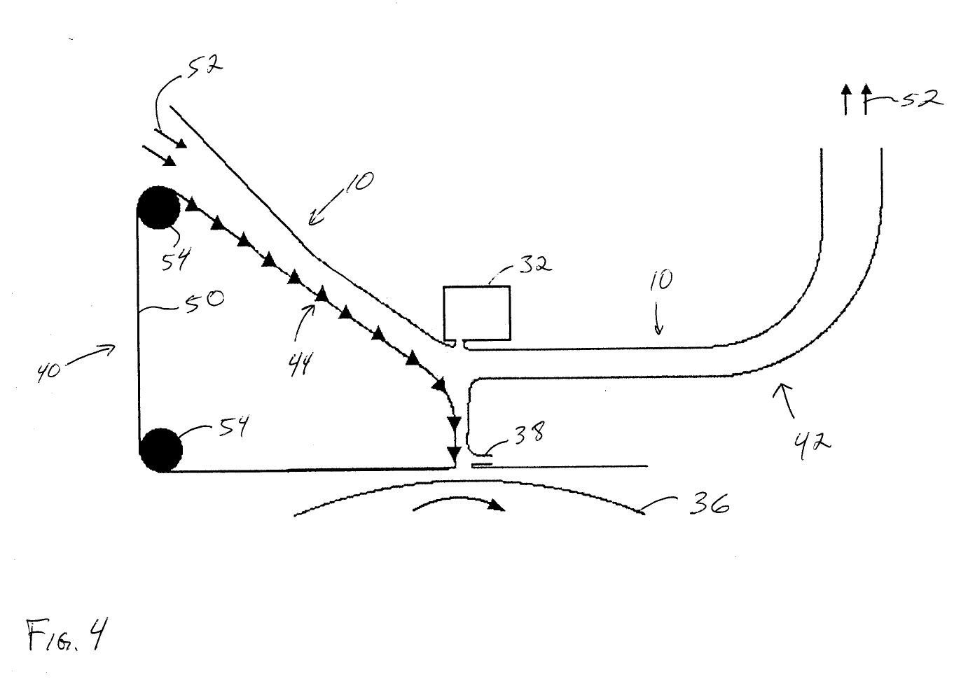

At least one wall 12 moves, or has a travel path, in the same direction as that of the fluid flow (represented by triangular arrows 20 in FIGS. 1A and 1B) when fluid flow device 10 is in operation. Movement of wall 12 can be accomplished using any device commonly used for this purpose. Examples of some of these types of devices are described in more detail below with reference to FIGS. 4 through 8. It is preferred that the velocity of moving wall 12 be substantially equal to the velocity of the fluid flow. However, the velocity of moving wall 12 can be different than the velocity of the fluid flow depending on the specific application being contemplated.

Fluid flow device 10a, 10b, can include moving walls and stationary or static walls. Alternatively, all of the walls can be moving. In FIG. 1A, both walls 12 of fluid flow device 10a are moving. However, the fluid flow device 10a shown in FIG. 1A can be configured with a moving wall and a stationary or static wall. In FIG. 1B, fluid flow device 10b includes a combination of walls 12 that are moving 12a and stationary or static 12b. However, the fluid flow device 10b shown in FIG. 1B can be configured with all moving walls.

Additional fluid passages can be included in the fluid flow device. Alternatively, the fluid flow device can be positioned around additional fluid passages. For example, fluid flow device 10b has an additional fluid flow passage 22. The direction of fluid flow in additional passage 22 is represented by arrows 24 in FIG. 1B. Fluid passages 14 and 22 form an angle 26 between each other. Angle 26 can be perpendicular or non-perpendicular. When angle 26 is non-perpendicular, it is preferably approximately 45 degrees.

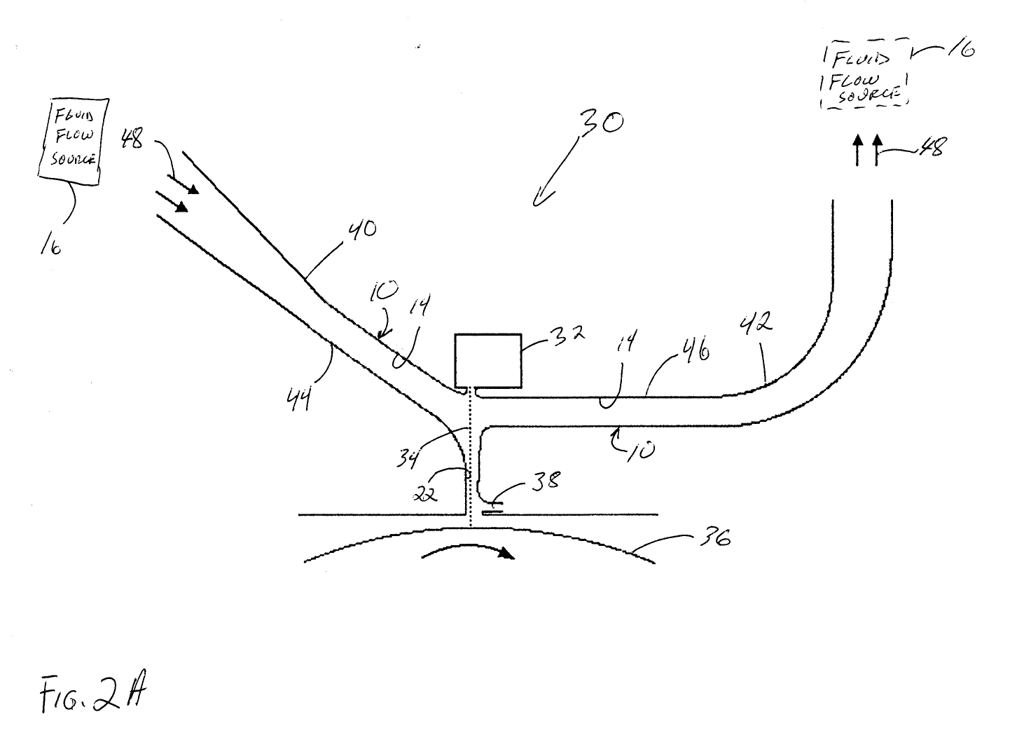

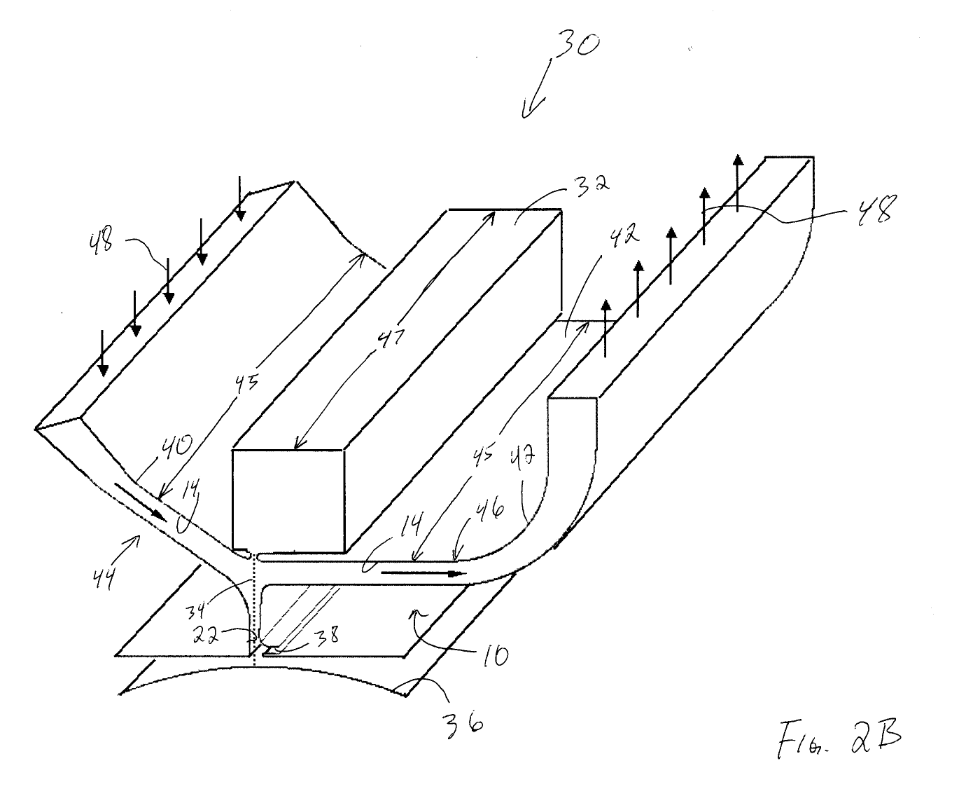

Referring to FIGS. 2A and 2B, a schematic side view of a printing system 30 incorporating an example embodiment of fluid flow device 10 is shown. Printing system 30 includes a printhead 32 positioned to eject drops 34 through additional passage 22 of fluid flow device 10. At least some the drops 34 contact a receiver (medium) 36 while other drops are collected by a catcher 38.

Printhead 32 includes a drop forming mechanism operable to form drops 34 having a plurality of volumes traveling along a first path. A drop deflector system including fluid flow device 10 applies a gas flow force to the drops traveling along the first path. The gas flow force is applied in a direction such that drops having one of the plurality of volumes diverge (or deflect) from the first path and begin traveling along a second path while drops having another of the plurality of volumes remain traveling substantially along the first path or diverge (deflect) slightly and begin traveling along a third path. Receiver 36 is positioned along one of the first, second and third paths while catcher 38 is positioned along another of the first, second or third paths depending on the specific application contemplated. Printheads like printhead 32 are known and have been described in, for example, U.S. Pat. No. 6,457,807 B1, issued to Hawkins et al., on Oct. 1, 2002; U.S. Pat. No. 6,491,362 B1, issued to Jeanmaire, on Dec. 10, 2002; U.S. Pat. No. 6,505,921 B2, issued to Chwalek et al., on Jan. 14, 2003; U.S. Pat. No. 6,554,410 B2, issued to Jeanmaire et al., on Apr. 29, 2003; U.S. Pat. No. 6,575,566 B1, issued to Jeanmaire et al., on Jun. 10, 2003; and U.S. Pat. No. 6,588,888 B2, issued to Jeanmaire et al., on Jul. 8, 2003.

After being ejected by the drop forming mechanism of printhead 32, drops 34 travel along the first path which is substantially perpendicular to printhead 32. Fluid flow device 10 of the drop deflector system is positioned at an angle 26 with respect to the path of ejected drops 34. Fluid flow device 10 includes an inlet portion 40 and an outlet portion 42 located on either side of the travel path. A fluid flow source 16 is operatively associated with one or both of the inlet portion 40 and the outlet portion 42. For example, pressurized gas, for example, air, from a pump can be introduced in the inlet portion 40 and/or a vacuum (negative air pressure relative to ambient operating conditions) from a vacuum pump can be introduced in the outlet portion 42. When fluid flow sources like these are introduced on the inlet portion 40 and the outlet portion 42 a sink for the fluid or gas flow is provided. The fluid or gas flow of the drop deflector interacts with ejected drops 34 and causes drops 34 to diverge or deflect as described above. The amount of deflection is volume dependent with smaller volume drops being deflected by the fluid or gas flow more than larger volume drops.

Any one of or all of walls 12 of fluid flow device 10 can be moveable in the example embodiment shown in FIGS. 2A and 2B. However, in this configuration, typically, one of or both of walls 44 and/or 46 are made to be moveable. Walls 44 and/or 46 move in the same direction as that of the fluid flow (represented by arrows 48 in FIGS. 2A and 2B) and, preferably, at substantially the same velocity as that of the fluid flow. However, the velocity of the moving walls 44 and/or 46 does not need to be substantially the same as that of the fluid flow. For example, the velocity of moving walls 44 can be slower than that of the fluid flow.

Typically, the width 45 of passage 14 is wider than the length 47 of the nozzle array of printhead 32 which helps to reduce or eliminate the boundary effects described above. However, passage 14 widths 45 that are equal to or less than the length 47 of the nozzle array of printhead 32 are permitted.

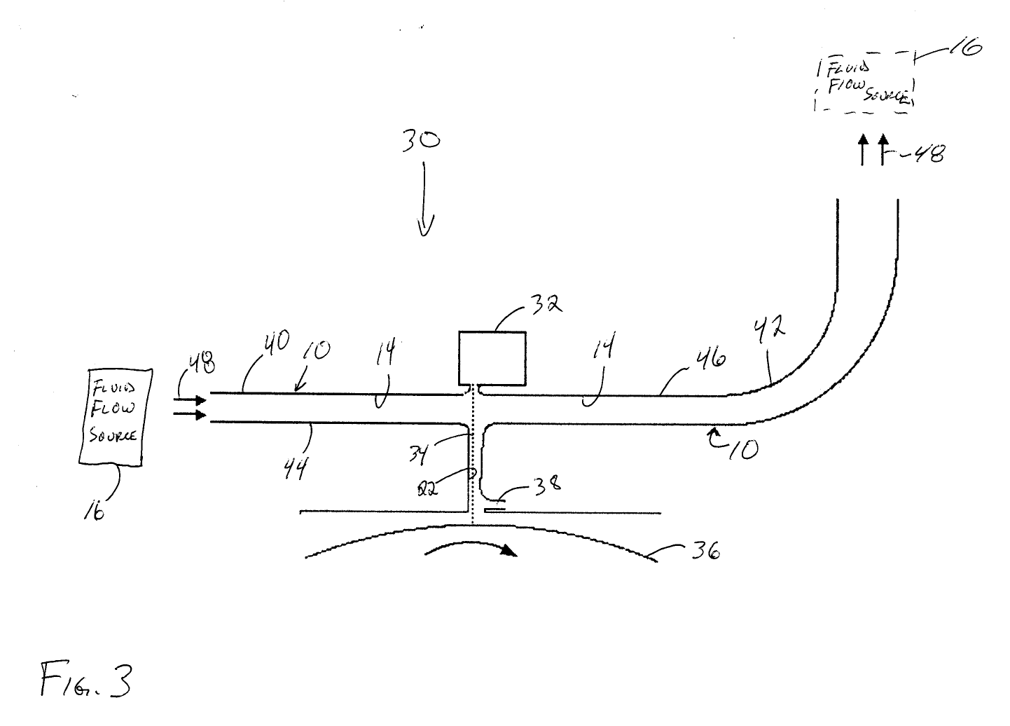

Referring to FIG. 3, a schematic side view of another printing system 30 incorporating another example embodiment of fluid flow device 10 is shown. In this embodiment, inlet portion 40 of fluid flow device is positioned perpendicular relative to the first travel path of drops 34. Any one of or all of walls 12 of fluid flow device 10 can be moveable in the example embodiment shown in FIG. 3. However, in this configuration, typically, one of or both of walls 44 and/or 46 are made to be moveable. Walls 44 and/or 46 move in the same direction as that of the fluid flow (represented by arrows 48 in FIG. 3) and, preferably, at substantially the same velocity as that of the fluid flow. However, the velocity of the moving walls 44 and/or 46 does not need to be substantially the same as that of the fluid flow. The other elements of the embodiment of printing system 30 shown in FIG. 3 are the same as the corresponding elements of the embodiment of printing system 30 shown in FIGS. 2A and 2B.

Referring to FIGS. 4 through 8, example embodiments of fluid flow device 10 are shown. The other elements of the embodiments of printing system 30 shown in these figures are the same as the corresponding elements of the embodiments of fluid flow device 10 or printing system 30 shown in FIGS. 1A, 1B, 2A, 2B, and 3.

Referring to FIG. 4, a schematic side view of another printing system 30 incorporating another example embodiment of fluid flow device 10 is shown. In this embodiment, inlet portion 40 of fluid flow device 10 is positioned at an angle relative to the first travel path of drops 34. Wall 44 of inlet portion 40 includes a flexible member 50, for example, a belt. Flexible member 50 is moveable and has a travel path that is in the same direction as that of the fluid flow (represented by arrows 52 in FIG. 4). Preferably, flexible member 50 moves at substantially the same velocity as that of the fluid flow. However, the velocity of flexible member 50 does not need to be substantially the same as that of the fluid flow.

Flexible member 50 can be a urethane belt(s) like those that are commercially available from Engineered Tilton Components, Tilton, N.H. It is preferable that the width of flexible member 50 be at least as wide as the length of the nozzle array of printhead 32 and, more preferable that the width of flexible member 50 be wider than the length of printhead 32 in order to help reduce or even eliminate boundary effects.

Movement of flexible member 50 can be accomplished using any known mechanism. For example, in the embodiment shown in FIG. 4, flexible member 50 moves through a path defined by at least one rotating member 54, for example, a pulley or a gear. One or more of the rotating members 54 can be motorized (not shown) to operate as the driving mechanism for moving flexible member 50.

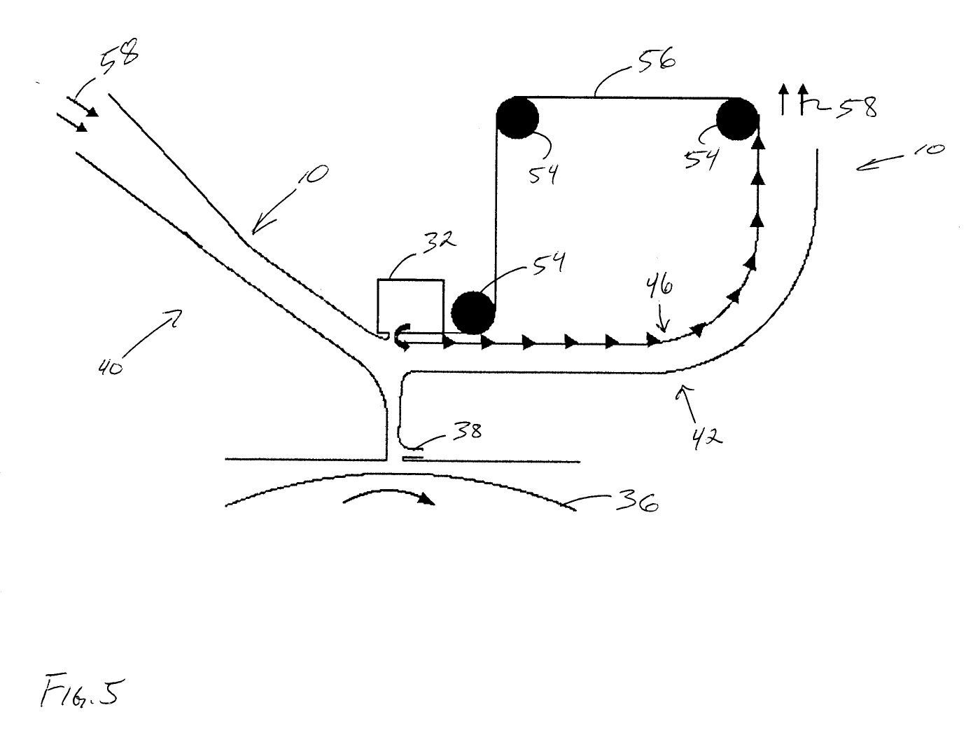

Referring to FIG. 5, a schematic side view of another printing system 30 incorporating another example embodiment of fluid flow device 10 is shown. In this embodiment, outlet portion 42 of fluid flow device 10 includes a moveable wall 46. Wall 46 of outlet portion 42 includes a flexible member 56, for example, a belt. Flexible member 56 is moveable and has a travel path that is in the same direction as that of the fluid flow (represented by arrows 58 in FIG. 5). Preferably, flexible member 56 moves at substantially the same velocity as that of the fluid flow. However, the velocity of flexible member 56 does not need to be substantially the same as that of the fluid flow.

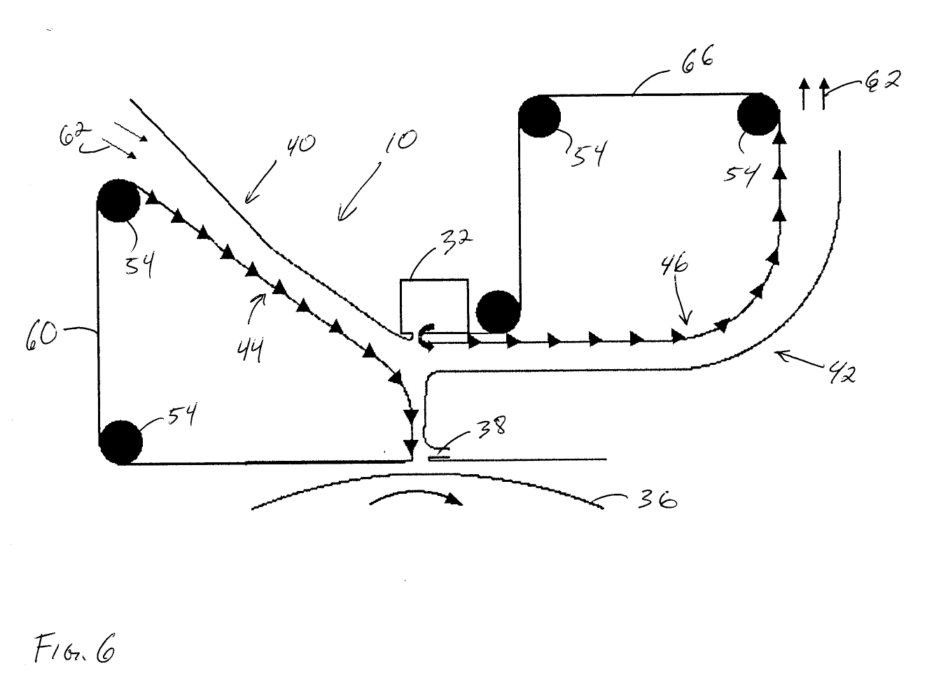

Referring to FIG. 6, a schematic side view of another printing system 30 incorporating another example embodiment of fluid flow device 10 is shown. In this embodiment, inlet portion 40 of fluid flow device 10 is positioned at an angle relative to the first travel path of drops 34. Wall 44 of inlet portion 40 includes a flexible member 60, for example, a belt. Flexible member 60 is moveable and has a travel path that is in the same direction as that of the fluid flow (represented by arrows 62 in FIG. 6). Preferably, flexible member 60 moves at substantially the same velocity as that of the fluid flow. However, the velocity of flexible member 60 does not need to be substantially the same as that of the fluid flow.

Outlet portion 42 of fluid flow device 10 includes a moveable wall 46. Wall 46 of outlet portion 42 includes a flexible member 66, for example, a belt. Flexible member 66 is moveable and has a travel path that is in the same direction as that of the fluid flow (represented by arrows 62 in FIG. 6). Preferably, flexible member 66 moves at substantially the same velocity as that of the fluid flow. However, the velocity of flexible member 66 does not need to be substantially the same as that of the fluid flow.

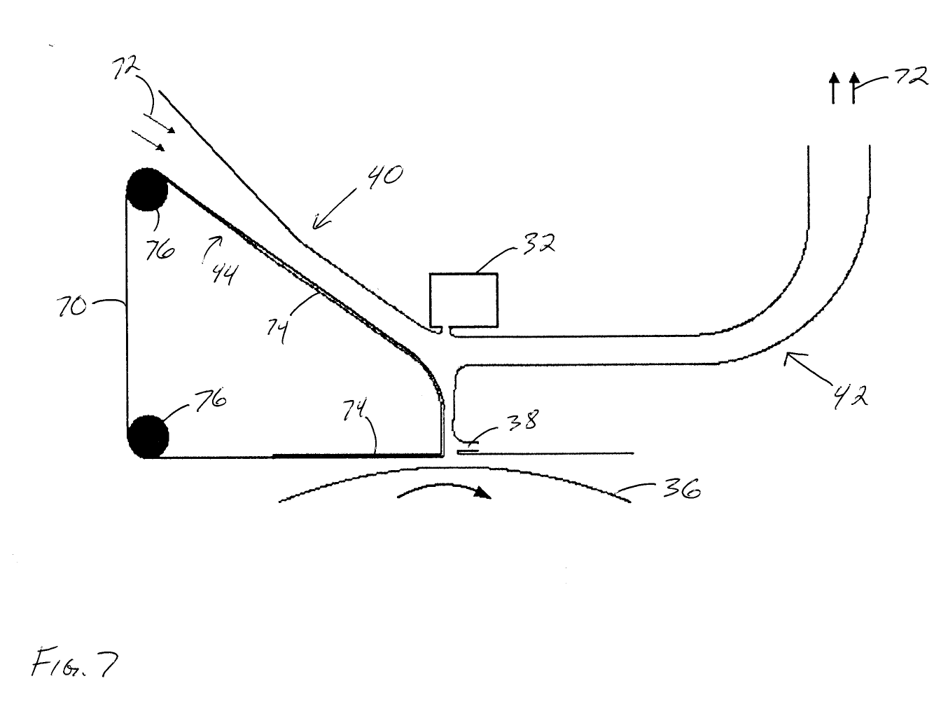

Referring to FIG. 7, a schematic side view of another printing system 30 incorporating another example embodiment of fluid flow device 10 is shown. In this embodiment, inlet portion 40 of fluid flow device 10 is positioned at an angle relative to the first travel path of drops 34. Wall 44 of inlet portion 40 includes a flexible member 70, for example, a belt. Flexible member 70 is moveable and has a travel path that is in the same direction as that of the fluid flow (represented by arrows 72 in FIG. 7). Preferably, flexible member 70 moves at substantially the same velocity as that of the fluid flow. However, the velocity of flexible member 70 does not need to be substantially the same as that of the fluid flow.

Flexible member 70 travels over a stationary structural member 74, for example, another wall of fluid flow device 10. Stationary structural member 74 can be operable to guide flexible member 70 in the direction of fluid flow. For example, stationary structural member 74 can be provided with grooves and/or ridges that help guide flexible member 70 through it travel path. Flexible member 70 can be driven and directed by rotators 76. At least one rotator 76 is operable to drive flexible member 70. It is preferable to have the widths of rotators 76 be substantially as wide as flexible member 70 in order to help flexible member 70 travel as smoothly as is possible.

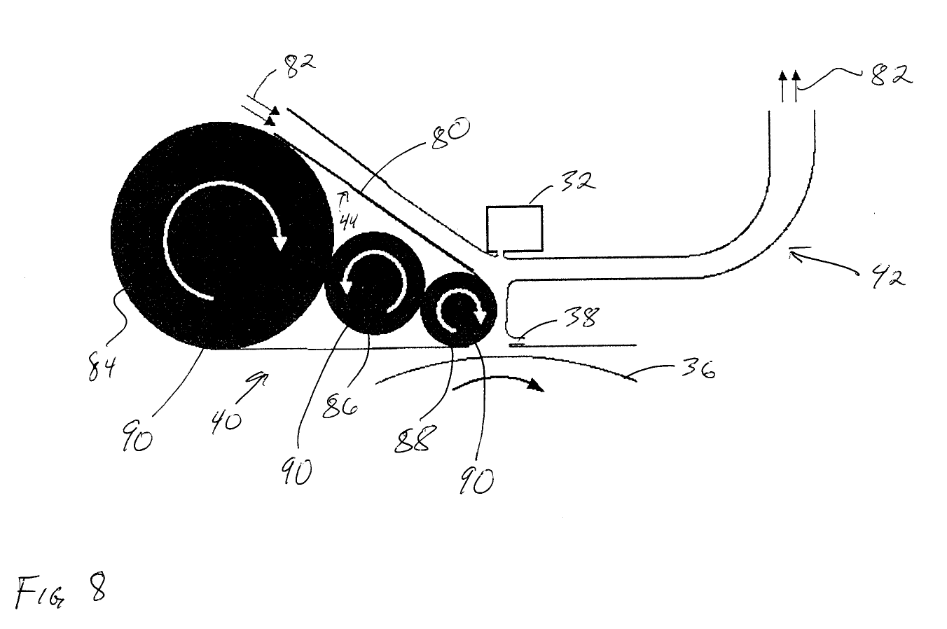

Referring to FIG. 8, a schematic side view of another printing system 30 incorporating another example embodiment of fluid flow device 10 is shown. In this embodiment, inlet portion 40 of fluid flow device 10 is positioned at an angle relative to the first travel path of drops 34. Wall 44 of inlet portion 40 includes a flexible member 80, for example, a belt. Flexible member 80 is moveable and has a travel path that is in the same direction as that of the fluid flow (represented by arrows 82 in FIG. 8). Preferably, flexible member 80 moves at substantially the same velocity as that of the fluid flow. However, the velocity of flexible member 80 does not need to be substantially the same as that of the fluid flow.

A plurality of rotatable members, for example, cylindrical drums 84, 86, 88 are positioned adjacent to each other. At least one of the drums 84, 86, 88 contacts another of the drums 84, 86, 88 which helps maintain structural stability and/or rigidity of the fluid flow device 10. Drums 84, 86, 88 are arranged so that flexible member 80 moves in the direction of fluid flow while maintaining a flat passage surface. For example, the axels 90 of drums 84, 86, 88 can be positioned normal to the flexible member intercept surface and parallel to each other. The specific number and size of drums 84, 86, 88 will vary depending on the size of the area space to be accommodated. It is preferable that the widths of the rotating members be as wide as that of flexible member 80. At least one of the rotating members can be configured to be driven. When this is done, the driven rotating member is operable to cause flexible member 80 to move in the direction of fluid flow.

Additionally, flow velocities of the fluid flow and the ejected drops can be adjusted in order to help reduce turbulence in the area of drop and fluid flow interaction. For example, either or both of these velocities can be adjusted such that the velocities are, preferably, substantially equivalent. This can be accomplished, for example, by measuring drop velocity using any known method and then adjusting the fluid flow source to provide the desired fluid flow velocity. When this is done, turbulence in the area of drop and fluid flow interaction can be reduced.

The invention has been described in detail with particular reference to certain preferred embodiments thereof, but it will be understood that variations and modifications can be effected within the scope of the invention.

### Parts List

10 fluid flow device
10a fluid flow device
10b fluid flow device
12 wall
12 at least one wall
12 wall
12 moving wall
12 both walls
12 combination of walls
12b static
14 passage
14 fluid passages
16 fluid flow source
16 positive pressure fluid flow source
16 negative pressure fluid flow source
18 arrows
20 triangular arrows
22 additional fluid flow passage
22 additional passage
22 fluid passage
24 arrows
26 angle
30 printing system
30 another printing system
32 printhead
34 eject drops
34 drops
34 form drops
34 ejected drops
36 receiver
38 catcher
40 inlet portion
42 outlet portion
44 wall
44 moving walls
44 wall
45 width
45 widths
46 moveable wall
46 wall
47 length
48 arrows
50 flexible member
50 moving flexible member
52 arrows
54 at least one rotating member
54 rotating members
56 flexible member
58 arrows
60 flexible member
62 arrows
66 flexible member
70 flexible member
70 guide flexible member
70 help guide flexible member
70 drive flexible member
70 help flexible member
72 arrows
74 stationary structural member
76 rotators
76 at least one rotator
80 flexible member
82 arrows
84 cylindrical drums
84 drums
90 axels

1. A fluid flow device comprising:
a passage for a fluid including a wall, the wall having a travel path; and
a fluid flow source operable to cause the fluid to flow in a direction through the passage, wherein the travel path of the wall is in the same direction as that of the fluid flow.

2. The device of claim 1, wherein the fluid is a gas.

3. The device of claim 1, further comprising:
at least one rotating member operable to move the wall of the passage in the direction of the fluid flow.

4. The device of claim 3, the at least one rotating member comprising a plurality of rotating members, wherein at least some of the plurality of rotating members are in contact with each other.

5. The device of claim 1, wherein the wall of the passage comprises a flexible member.

6. The device of claim 5, wherein the flexible member includes a belt.

7. The device of claim 5, the passage comprising a stationary structural member, wherein the flexible member is located between the stationary structural member and the fluid flow.

8. The device of claim 5, the passage comprising a stationary structural member, wherein the stationary structural member is operable to guide the flexible member in the direction of the fluid flow.

9. The device of claim 1, the wall having a velocity, the fluid flow having a velocity, wherein the velocity of the wall is substantially equal to the velocity of the fluid flow.

10. A printing system comprising:
a liquid drop ejector operable to eject liquid drops having a plurality of volumes along a first path;
a passage for a fluid including a wall, the wall having a travel path; and
a fluid flow source operable to cause the fluid to flow in a direction through the passage, the travel path of the wall being in the same direction as that of the fluid flow, wherein interaction of the fluid flow and the liquid drops causes liquids drops having one of the plurality of volumes to begin moving along a second path.

11. The system of claim 10, wherein the direction of fluid flow is perpendicular relative to the first path.

12. The system of claim 10, wherein the direction of fluid flow is non-perpendicular relative to the first path.

13. The system of claim 10, the passage including an inlet portion located on one side of the liquid drop ejector and an outlet portion located on another side of the liquid drop ejector, wherein the wall is operatively associated with the inlet portion of the passage.

14. The system of claim 13, wherein the fluid flow source includes a vacuum source operatively associated with the outlet portion of the passage.

15. The system of claim 13, wherein the fluid flow source includes a fluid flow generator operatively associated with the inlet portion of the passage.

16. The system of claim 10, the passage including an inlet portion located on one side of the liquid drop ejector and an outlet portion located on another side of the liquid drop ejector, wherein the wall is operative associated with the outlet portion of the passage.

17. The system of claim 16, wherein the fluid flow source includes a fluid flow generator operatively associated with the inlet portion of the passage.

18. The system of claim 10, the passage including an inlet portion located on one side of the liquid drop ejector and an outlet portion located on another side of the liquid drop ejector, the wall including a plurality of walls, wherein one of the plurality of walls is operative associated with the inlet portion of the passage, and another of the plurality of walls is operative associated with the outlet portion of the passage.

19. The system of claim 18, wherein the fluid flow source includes a fluid flow generator operatively associated with the inlet portion of the passage.

20. The system of claim 10, wherein the fluid is a gas.

21. The system of claim 10, further comprising:
at least one rotating member operable to move the wall of the passage in the direction of the fluid flow.

22. The system of claim 21, the at least one rotating member comprising a plurality of rotating members, wherein at least some of the plurality of rotating members are in contact with each other.

23. The system of claim 10, wherein the wall of the passage comprises a flexible member.

24. The system of claim 23, wherein the flexible member includes a belt.

25. The system of claim 23, the passage comprising a stationary structural member, wherein the flexible member is located between the stationary structural member and the fluid flow.

26. The system of claim 23, the passage comprising a stationary structural member, wherein the stationary structural member is operable to guide the flexible member in the direction of the fluid flow.

27. The system of claim 10, the wall having a velocity, the fluid flow having a velocity, wherein the velocity of the wall is substantially equal to the velocity of the fluid flow.

28. A method of moving fluid comprising:
providing a passage including a wall;
providing a fluid flow from a fluid flow source, the fluid moving in a direction through the passage; and
moving the wall along a travel path in the same direction as that of the fluid flow.

29. The method of claim 28, the wall moving at a velocity, the fluid flow moving at a velocity, wherein the velocity of the wall is substantially equal to the velocity of the fluid flow.
